(19) United States
(12) Patent Application Publication
(10) Pub. No.: US 2021/0147648 A1
(43) Pub. Date: May 20, 2021

(54) FLEXIBLE HARDCOAT DISPOSED BETWEEN ORGANIC BASE MEMBER AND SILICEOUS LAYER AND CLEANABLE ARTICLES

(71) Applicant: 3M INNOVATIVE PROPERTIES COMPANY, St Paul, MN (US)

(72) Inventors: Richard J. Pokorny, Maplewood, MN (US); Joan M. Noyola, Maplewood, MN (US); Zachary J. Malmberg, Roseville, MN (US); Thomas P. Klun, Lakeland, MN (US); Moses M. David, Wells, TX (US); Jun Ma, Woodbury, MN (US); Cordell M. Hardy, Woodbury, MN (US); Chad M. Amb, Roberts (MN)

(21) Appl. No.: 17/254,483

(22) PCT Filed: Aug. 14, 2019
(86) PCT No.: PCT/IB2019/056896

§ 371 Date: Dec. 21, 2020

Related U.S. Application Data
(60) Provisional application No. 62/718,680, filed on Aug. 14, 2018.

(51) Int. Cl. C08J 7/04; C08J 7/046; C08J 7/06; B32B 27/08; B32B 27/30; B32B 27/40; B32B 27/32

(52) U.S. Cl. CPC C08J 7/0423; C08J 7/046; C08J 7/065; B32B 27/08; B32B 2250/04; B32B 27/40; B32B 27/32; C08J 2327/06; C08J 2375/16; B32B 27/308

(57) ABSTRACT

Articles and intermediates are described comprising an organic polymeric base member and a hardcoat layer disposed on the organic polymeric base member, wherein the hardcoat layer can be stretched 25-75% without cracking. A siliceous layer is disposed on the hardcoat layer. The siliceous layer has a porosity of no greater than 10% and a thickness no greater than 1 micron. In some embodiments, the article further comprises a surface layer comprising a zwitterionic compound bonded to the siliceous layer.

### SUMMARY

In one embodiment, an article is described comprising an organic polymeric base member; a hardcoat layer disposed on the organic polymeric base member, wherein the hardcoat layer can be stretched 25-75% without cracking; a siliceous layer disposed on the hardcoat layer, wherein the siliceous layer has a porosity of no greater than 10% and a thickness no greater than 1 micron; and a surface layer comprising a zwitterionic compound bonded to the siliceous layer.

The organic polymeric base member (e.g. film) and article preferably exhibit a load at 25% strain/mm of no greater than 20 N/cm film width. In some embodiments, the organic polymeric base member (e.g. film) has an elongation at break of at least 150%. The load at 25% strain/cm film width and elongation are determined with tensile testing utilizing a strain rate of 200%/min. The hardcoat typically has a thickness of 2 to 10 microns. The hardcoat typically comprises at least one urethane (meth)acrylate oligomer having an elongation at break of at least 50, 75, or 100%.

In another embodiment, an article is described comprising an organic polymeric base member; a hardcoat layer disposed on the organic polymeric film, wherein the hardcoat layer can be stretched 25-75% without cracking; a siliceous layer disposed on the hardcoat layer, wherein the siliceous layer has a porosity of no greater than 10% and a thickness no greater than 1 micron.

In another embodiment, an article or intermediate is described comprising a hardcoat layer, wherein the hardcoat layer can be stretched 25-75% without cracking; and a siliceous layer disposed on the hardcoat layer, wherein the siliceous layer has a porosity of no greater than 10% and a thickness no greater than 1 micron.

### BRIEF DESCRIPTION OF DRAWING

The invention is further explained with reference to the drawing wherein:

FIG. 1 is a schematic view of an illustrative three-layer article;

FIG. 2 is a schematic view of another illustrative embodied article;

FIG. 3 is a schematic view of a two-layer embodiment.

These FIGURES are not to scale and are intended to be merely illustrative and not limiting.

### DETAILED DESCRIPTION OF ILLUSTRATIVE EMBODIMENTS

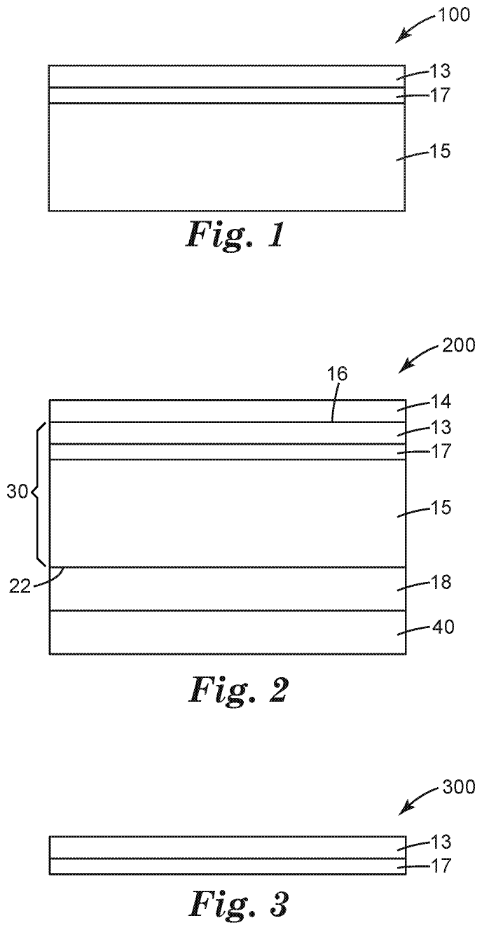

FIG. 1 shows an illustrative three-layer article 100 comprising an organic polymeric base member 15, a siliceous layer 13, and a hardcoat layer 17 disposed between siliceous layer 13 and organic polymeric film 15.

FIG. 2 shows another embodied article 200 comprising a three-layer article 30 further comprising a surface layer 14 bonded to the front surface 16 of a siliceous layer 13.

FIG. 3 shows an illustrative two-layer article 300 comprising siliceous layer 13 and hardcoat layer 17.

Articles 100, 200 and 300 may optionally further comprise an adhesive layer 18 and removable liner 24 on the back surface 22 as depicted in FIG. 2

In each of these embodiments, the organic polymeric base member 15 is typically a substantially planar film and may be characterized as a (e.g. preformed) polymeric film. However, in other embodiment, the base member but may also be configured in curved, complex, as well as three-dimensional shapes, such as in the case of an object.

The conformable film may be characterized by tensile testing, as determined by the test method described in the examples, utilizing a strain rate of 200%/min.

Conformable films generally have a lower tensile modulus in comparison to polyester (PET). For example, PET has a tensile modulus of at least 5000-6000 MPa; while conformable films typically have a tensile modulus less than 3000 MPa. In some embodiments, such as in the case of polyvinyl chloride (PVC) films, the tensile modulus of the conformable film has a tensile modulus of less than 2500, 2000, or 1500 MPa. In other embodiments, such as in the case of certain polyurethane (PUR) films, the tensile modulus of the conformable film is less than 1000, 750, 500, or 250 MPa. In some embodiments, the tensile modulus of the conformable film is less than 200, 150, or 100 MPa. The conformable film typically has a tensile modulus of at least 25, 30, 35, 40, 45, or 50 MPa. In some embodiments, the conformable film has a tensile modulus of at least 100, 200, 300, 400, or 500 MPa.

Conformable films generally have a lower ultimate tensile strength in comparison to polyester (PET). For example, PET has an ultimate tensile strength of at least 150 MPa; while conformable films typically have an ultimate tensile strength less than 100 MPa. The conformable film typically has an ultimate tensile strength of at least 10, 15, or 20 MPa. In some embodiments, the conformable film has an ultimate tensile strength of at least 30, 35, 40, or 45 MPa.

Conformable films generally have a higher tensile strain at break or in other words higher elongation at break in comparison to polyester (PET). For example, PET has a tensile strain at break of less than 100%; while conformable films typically have a tensile strain at break of at least 150, 175, or 200%. In some embodiments, the conformable film has a tensile strain at break of at least 225, 250, 275, 300, 325, or 350%. The conformable film typically has a tensile strain at break of no greater than 500%.

Conformable films generally have a lower load at 25% strain in comparison to polyester (PET). For example, PET has a load at 25% strain of at least 150 N/cm film width; while conformable films typically have a load at 25% strain of less than 50, 40, 30, 20, or 10 N/cm film width. In some embodiments, the conformable film has a load at 25% strain of at least 2, 3, 4, or 5 N/cm film width.

The load at 25% strain/cm film width is surmised important for stretching films by hand and/or applying films to objects by hand. If a film has too high of load at a desired strain, most people will not be able to stretch or apply such film by hand to an object due to the excessive force required to stretch the film. For example, a typical person can apply a 50N force by hand. This is sufficient force to stretch a 5 cm wide conformable film 25%. However, most people would not be able to stretch PET films by hand as this would require over 700 N of force to stretch a 5 cm wide film 25%

Various highly flexible and/or conformable films are known including for example, polyvinyl chloride (PVC), plasticized polyvinyl chloride, certain polyurethane, polyolefins such as low density polyethylene (e.g. density of 0.917-0.930 g/cm³), elastomeric polypropylene (e.g. having a crystallinity less than 70%), and fluoroelastomers. Although the hardcoat described herein is particularly advantageous as a layer disposed between a conformable organic (e.g.) film base member and a siliceous layer, the hardcoat layer and siliceous layer can also be utilized with base member (e.g. films) that are not conformable. In some embodiments, the film can be colored by inclusion of pigments and/or dyes.

In some embodiments, the highly flexible and/or conformable film is a thermoplastic polyurethane film as described in U.S. Application No. 62/561,472 filed Sep. 21, 2017; incorporated herein by reference. The polyurethane is typically the reaction product of a polyester polyol having a melting temperature of at least about 30° C. Illustrative polyester diols include polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, and copolymers thereof. In some embodiments, the thermoplastic polyurethane film comprises hard segments in a range of from about 40 wt. % to about 55 wt. %. The hard segments are typically derived from an aliphatic diisocyante having a cyclic moiety such as dicyclohexylmethane-4,4′-diisocyanate, isophorone diisocyanate, hexamethylene diisocyanate, poly(hexamethylene diisocyanate), 1,4-cyclohexylene diisocyanate, and a chain extender diol, such as butane diol.

The thickness of the (e.g. conformable) organic polymeric film can vary and will typically depend on the intended use of the final article. In some embodiments, the film thickness is less than about 0.5 mm and typically between about 0.02 and about 0.2 mm. In some embodiments, the thickness of the (e.g. conformable) organic polymeric film is at least 2, 3, 4, 5, or 6 mils. In some embodiments, the thickness of the (e.g. conformable) organic polymeric film is no greater than 10 or 15 mils.

The (e.g. conformable) organic polymeric film may be opaque or light-transmissive (e.g. translucent or transparent). The term light-transmissive means transmitting at least about 85% of incident light in the visible spectrum (about 400 to about 700 nm wavelength). Substrates may be colored.

In some embodiments, the hardcoat layer, siliceous layer, and adhesive (when present) are also light transmissive such that each of such layers and combinations thereof are light-transmissive as just described.

In typical embodiments, the (e.g. conformable) organic polymeric film will be substantially self-supporting, i.e., sufficiently dimensionally stable to hold its shape as it is moved, used, and otherwise manipulated. In some embodiments, the article will be further supported in some fashion, e.g., with a reinforcing frame, adhered to a supporting surface, etc.

In some embodiments, the (e.g. conformable) organic polymeric film may be provided with graphics on the surface thereof or embedded therein, such as words or symbols as known in the art, which will be visible through surface layer 14.

Organic polymer base films can be formed using conventional filmmaking techniques. The conformable organic polymeric film 15 can be treated to improve adhesion with the adjacent any. Exemplary of such treatments include chemical treatment, corona treatment (e.g., air or nitrogen corona), plasma, flame, or actinic radiation. Interlayer adhesion can also be improved with the use of an optional tie layer or primer applied.

When the finished articles are intended to be used in display panels or as an overlaminate for a graphics film, the (e.g. conformable) organic polymeric film 15, and other components (e.g. adhesive 18, hardcoat layer 17, siliceous layer 13 and surface layer 14) of article 10 are also typically light transmissive, as previously described.

At least a portion of the front surface of the (e.g. conformable) organic polymeric film 15, and in typical embodiments the entire front surface thereof, is siloxane-bondable, i.e., capable of forming siloxane bonds with a silane compound.

This capability can be provided by formation of a siliceous layer 13 on a major surface of the (e.g. conformable) organic polymeric film 15.

The siliceous layer is generally a continuous layer having a low level of porosity. For example, when a siliceous layer comprises a dried network of acid-sintered nanoparticles as described in WO2012/173803, the siliceous layer of sintered nanoparticles has a porosity of 20 to 50 volume percent, 25 to 45 volume percent, or 30 to 40 volume percent. Porosity may be calculated from the refractive index of the (sintered nanoparticle) primer layer coating according to published procedures such as in W. L. Bragg and A. B. Pippard, Acta Crystallographica, 6, 865 (1953). In contrast the siliceous layer described herein has a porosity less than 20, 15 or 10 volume percent. In some embodiments, the siliceous layer has a porosity of less than 9, 8, 7, 6, 5, 4, 3, 2, or 1 percent.

Fused silica is reported to have a refractive index of 1.458. Since air has a refractive index of 1.0, a porous siliceous layer has a lower refractive index than fused silica. For example, when the siliceous layer has a porosity of 20 volume percent, the calculated refractive index would be 1.164.

In some embodiments, siliceous layer 13 further comprises carbon. For example, the siliceous layer may contain from about 10 to about 50 atomic percent carbon. Due to the inclusion of the carbon in combination with the low porosity, the siliceous layer can have a refractive index greater than 1.458 (i.e. fused silica). For example, the refractive index of the siliceous layer can be at least 1.48, 1.49, 1.50, 1.51, 1.52, 1.53, 1.54, 1.55, 1.56, 1.57, 1.58, 1.59, or 1.60. As the carbon content increase from 30 to 50 atomic percent carbon the refractive index also increases. In some embodiments, the refractive index can range up to 2.2.

The atomic composition (e.g. silicon, carbon, oxygen) of the siliceous layer can be determined by Electron Spectroscopy for Chemical Analysis (ESCA). The presence of Si—C bonding can be determined by Fourier Transform Infrared Spectroscopy (FTIR). Optical properties, such as refractive index, can be determined by Ellipsometry.

In one favored embodiments, the siliceous layer is a diamond-like glass (“DLG”) film, such as described in U.S. Pat. No. 6,696,157 (David et al.). An advantage of such material is that in addition to providing the siloxane-bondable front surface on the body member, such DLG can also provide improved stiffness, dimensional stability, and durability. This is particularly helpful when the underlying components of the base member may be relatively softer.

Illustrative diamond-like glass materials suitable for use herein comprise a carbon-rich diamond-like amorphous covalent system containing carbon, silicon, hydrogen and oxygen. The absence of crystallinity of the amorphous siliceous (e.g. DLG) layer can be determined by X-Ray Diffraction (XRD). The DLG is created by depositing a dense random covalent system comprising carbon, silicon, hydrogen, and oxygen under ion bombardment conditions by locating a substrate on a powered electrode in a radio frequency (“RF”) chemical reactor. In specific implementations, DLG is deposited under intense ion bombardment conditions from mixtures of tetramethylsilane and oxygen. Typically, DLG shows negligible optical absorption in the visible and ultraviolet regions, i.e., about 250 to about 800 nm. Also, DLG usually shows improved resistance to flex-cracking compared to some other types of carbonaceous films and excellent adhesion to many substrates, including ceramics, glass, metals and polymers.

DLG typically contains at least about 30 atomic percent carbon, at least about 25 atomic percent silicon, and less than or equal to about 45 atomic percent oxygen. DLG typically contains from about 30 to about 50 atomic percent carbon. In specific implementations, DLG can include about 25 to about 35 atomic percent silicon. Also, in certain implementations, the DLG includes about 20 to about 40 atomic percent oxygen. In specific advantageous implementations the DLG comprises from about 30 to about 36 atomic percent carbon, from about 26 to about 32 atomic percent silicon, and from about 35 to about 41 atomic percent oxygen on a hydrogen free basis. “Hydrogen free basis” refers to the atomic composition of a material as established by a method such as Electron Spectroscopy for Chemical Analysis (ESCA), which does not detect hydrogen even if large amounts are present in the thin films.

The (e.g. DLG) siliceous layer can made to a specific thickness, typically ranging from at least 50, 75 or 100 nm up to 10 microns. In some embodiments, the thickness is no greater than 5, 4, 3, 2, or 1 micron. In some embodiments, the thickness is less than 1 micron, 900 nm, 800 nm, 700 nm, 600 nm, 500 nm, 400 nm, 300 nm, or 200 nm.

As depicted in FIGS. 1-2, a hardcoat layer is provided between the siliceous (e.g. DLG film) layer and the (e.g. flexible and/or conformable) organic polymeric base member (e.g. film).

The hardcoat layer can improve adhesion between a siliceous layer and the conformable organic polymeric film. The hardcoat layer can also improve the stiffness, dimensional stability, and durability; particularly when the siliceous layer is of a minimal thickness. In favored embodiments, the hardcoat layer (e.g. having a thickness of 5 microns) can be stretched 25, 50, or 75% at a rate of about 2 cm/second and maintained in the stretched condition for 1 hour without cracking (as further described in the Maximum Elongation without Cracking test described in the examples.)

The hardcoat compositions are formed from the reaction product of a polymerizable composition comprising one or more urethane (meth)acrylate oligomer(s). Typically, the urethane (meth)acrylate oligomer is a di(meth)acrylate. The term “(meth)acrylate” is used to designate esters of acrylic and methacrylic acids.

In some embodiments, the urethane (meth)acrylate oligomer is synthesized from reacting a polyisocyanate compound with a hydroxyl-functional acrylate compound.

A variety of polyisocyanates may be utilized in preparing the urethane (meth)acrylate oligomer. “Polyisocyanate” means any organic compound that has two or more reactive isocyanate (—NCO) groups in a single molecule such as diisocyanates, triisocyanates, tetraisocyanates, etc., and mixtures thereof. For improved weathering and diminished yellowing, the urethane (meth)acrylate oligomer(s) employed herein are preferably aliphatic and therefore derived from an aliphatic polyisocyanate. However, small concentrations of aromatic polyisocyanates can be usefully employed in combination with (e.g. linear aliphatic polyisocyanates, as described herein.

The urethane (meth)acrylate oligomer is typically the reaction product of hexamethylene diisocyanate (HDI), or derivatives thereof. In one embodiment, the urethane (meth)acrylate oligomer is the reaction product of hexamethylene-1,6-diisocyanate, such as “Desmodur™ I”. In another embodiment, the urethane (meth)acrylate oligomer is the reaction product of dicyclohexylmethane diisocyanate, such as “Desmodur™ W”. HDI derivatives include, but are not limited to, polyisocyanates containing biuret groups, such as the biuret adduct of hexamethylene diisocyanate (HDI) available from Covestro LLC under the trade designation “Desmodur N-100”, polyisocyanates containing isocyanurate groups, such as those available from Covestro under trade designation “Desmodur N-3300”, as well as polyisocyanates containing urethane groups, uretdione groups, carbodiimide groups, allophonate groups, and the like. Yet another useful derivative, is a hexamethylene diisocyanate (HDI) trimer, such as those available from Covestro under trade designation “Desmodur N-3800”.

In some embodiments, the urethane (meth)acrylate oligomer is the reaction product of a hexamethylene diisocyanate (HDI) having an NCO content of at least 10, 15, 20, or 25 wt. %. The NCO content is typically no greater than 50, 45, 40, or 35 wt. %. The polyisocyanate typically has an equivalent weight of at least 50 or 75 and in some embodiments at least 100, or 125. The equivalent weight is typically no greater than 500, 450, or 400 and in some embodiments no greater than 350, 300, or 250 grams/per NCO group.

The hexamethylene diisocyanate (HDI) polyisocyanate is typically reacted with hydroxyl-functional acrylate compounds and optionally polyols.

In typical embodiments, the polyisocyanate is reacted with a hydroxyl-functional acrylate compound having the formula HOQ(A)p; wherein Q is a divalent organic linking group, A is a (meth)acryl functional group —XC(O)C(R₂)═CH₂ wherein X is O, S, or NR wherein R is H or C1-C4 alkyl, R₂ is a lower alkyl of 1 to 4 carbon atoms or H; and p is 1 to 6. The —OH group reacts with the isocyanate group forming a urethane linkage.

Q is independently a straight or branched chain or cycle-containing connecting group. Q can include a covalent bond, an alkylene, an arylene, an aralkylene, an alkarylene. Q can optionally include heteroatoms such as 0, N, and S, and combinations thereof. Q can also optionally include a heteroatom-containing functional group such as carbonyl or sulfonyl, and combinations thereof.

In some embodiments, the hydroxyl-functional acrylate compounds used to prepare the urethane (meth)acrylate oligomer are monofunctional, such as in the case of hydroxyl ethyl acrylate, hydroxybutyl acrylate, caprolactone monoacrylate, available as SR495 from Sartomer, and mixtures thereof. In this embodiment, p=1.

In another embodiment, the hydroxyl-functional acrylate compounds used to prepare the urethane (meth)acrylate oligomer can be multifunctional, such as the in the case of glycerol dimethacrylate, 1-(acryloxy)-3-(methacryloxy)-2-propanol (CAS number 1709-71-3), pentaerythritol triacrylate. In this embodiment, p is at least 2, 4, 5, or 6. When hydroxyl-functional multi-acrylate compounds are utilized, the concentration of such is typically no greater than 10, 9, 8, 7, 6, 5, 4, 3, 2, or 1 wt. % of the total hydroxy-functional acrylate compounds utilized to prepare the urethane (meth)acrylate oligomer.

In some embodiments, the polyisocyanate can be reacted with one or more hydroxyl-functional acrylate compounds and a polyol. In one embodiment, the polyol is an alkoxylated polyol available from Perstorp Holding AB, Sweden under the trade designation “Polyol 4800”. Such polyols can have a hydroxyl number of 500 to 1000 mg KOH/g and a molecular weight ranging from at least 200 or 250 g/mole up to about 500 g/mole. Such polyols are typically described as crosslinkers for polyurethanes.

In another embodiment, the polyol may be a linear or branched polyester diol derived from caprolactone. Polycaprolactone (PCL) homopolymer is a biodegradable polyester with a low melting point of about 60° C. and a glass transition temperature of about −60° C. PCL can be prepared by ring opening polymerization of epsilon-caprolactone using a catalyst such as stannous octanoate, as known in the art. One suitable linear polyester diols derived from caprolactone is Capa™ 2043, reported to have a hydroxyl number of 265-295 mg KOH/g and a mean molecular weight of 400 g/mole.

In another embodiment, the polyol may be polycarbonate diol derived from linear or branched C4-C10 diols such as hexane diol (HD) and 3-methyl-1,5-pentane diol (MPD).

Notably, the hydroxyl-functional acrylate compound (HEA or SR495B), and (e.g. caprolactone) diol used in the preparation of the urethane (meth)acrylate oligomer are also aliphatic, lacking aromatic moieties. Thus, the urethane (meth)acrylate oligomer can contain little or no aromatic moieties. In some embodiments, the concentration of aromatic moieties is no greater than 10, 9, 8, 7, 6, 5, 4, 3, 2, or 1 wt. %, based on the total weight of the urethane (meth)acrylate oligomer.

One suitable urethane (meth)acrylate oligomer that can be employed in the hardcoat composition is available from Sartomer Company (Exton, Pa.) under the trade designation “CN991”

Other suitable urethane (meth)acrylate oligomers are available from Sartomer Company under the trade designations “CN9001” and “CN981B88”. CN981B88” is an aliphatic urethane (meth)acrylate oligomer available from Sartomer Company under the trade designation CN981 blended with SR238 (1,6 hexanediol diacrylate). The physical properties of these aliphatic urethane (meth)acrylate oligomers, as reported by the supplier, are set forth as follows:

| | | | | | Tg (° C.) as |
|---|---|---|---|---|---|
| Trade | Viscosity | Ultimate Tensile | | Elongation | determined |
| Designation | Cps at 60° C. | Strength* | | at Break* | by DSC* |
| CN981 | 6190 | 1113 | psi (7.7 MPa) | 81 | 22 |
| CN981B88 | 1520 | 1520 | psi (10.5 MPa) | 41 | 28 |
| CN9001 | 46,500 | 3295 | psi (22.7 MPa) | 143 | 60 |
| CN991 | 660 | 5,378 | psi (37.1 MPa) | 79 | 27 |

*as reported by supplier

The reported tensile strength, elongation, and glass transition temperature (Tg) properties are based on a homopolymer prepared from such urethane (meth)acrylate oligomer.

Suitable urethane (meth)acrylate oligomers can be characterized as having an elongation at break of at least 25% and typically no greater than 150% or 200%; a Tg ranging from about 0 to 30, 40, 50, 60 or 70° C.; and a tensile strength of at least 1,000 psi (6.9 MPa), or at least 5,000 psi (34.5 MPa).

In some embodiments, the elongation at break of the urethane (meth)acrylate oligomer or hardcoat composition is at least 25, 30, 35, 40, 45, 50, 55, 60, 65, 70, or 75%. The elongation at break can be a higher value than the elongation without cracking according to the test method described in the examples. For example, CN991 has an elongation at break of 79%. However, cracks are evident when a 5 micron thick cured coating was stretched 75%. However, according to Example 1, cracks were not evident when a 5 micron thick cured coating was stretched 50%. Conversely, according to Example 5, cracks were not evident when a 5 micron thick cured coating was stretched 75%. Thus, PUA1, as further described in the examples, has an elongation at break greater than 75%.

The molecular weight of the urethane (meth)acrylate oligomer(s) typically ranges from 800 to 5000 g/mole; as can be determined by gel permeation chromatography (GPC) utilizing polystyrene standards. In some embodiments, the molecular weight of the urethane (meth)acrylate oligomer(s) is no greater than 4500, 4000, or 3500 g/mole.

These embodied urethane (meth)acrylate oligomers and other urethane (meth)acrylate oligomers having similar physical properties can usefully be employed at concentration of at least 40 or 50 wt. % ranging up to 100 wt. % based on wt. % solids of the organic component of the hardcoat composition. In some embodiments, the concentration of urethane (meth)acrylate oligomers is at least 45, 50, 55, 60, 65, 70, 75, 80, 85, 90, or 95 wt. % solids of the organic components of the hardcoat composition.

In some embodiments, the urethane (meth)acrylate oligomer is combined with at least one multi(meth)acrylate monomer comprising at least two (meth)acrylate groups. The multi(meth)acrylate monomer generally has a lower molecular weight than the urethane (meth)acrylate oligomer and thereby increases the crosslinking density, as well as increase adhesion to the organic polymeric film and siliceous layer.

Suitable di(meth)acrylate monomers monomers include for example 1,3-butylene glycol diacrylate, 1,4-butanediol diacrylate, 1,6-hexanediol di (meth)acrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate. In some embodiments, the urethane (meth)acrylate oligomer may be purchased preblended with a di(meth)acrylate monomer such as in the case of CN988B88”.

In some embodiments, the amount of di(meth)acrylate monomer is at least 5, 10, 15, 20, 25, 30, 35, 40, 45, 50, 55 or 60 wt. % solids of the organic components of the hardcoat composition.

Substantial concentrations of (meth)acrylate monomer having greater than two (meth)acrylate groups can reduce the flexibility of the hardcoat layer. Hence, when such monomers are employed, the concentration is typically no greater than 10, 9, 8, 7, 6, 5, 4, 3, 2, or 1 wt.-% solids of the total hardcoat composition. In some embodiments, the hardcoat composition is free of monomers comprising more than two (meth)acrylate groups.

Higher functionality (meth)acryl containing compounds include ditrimethylolpropane tetraacrylate, ethoxylated (4) pentaerythritol tetraacrylate, and pentaerythritol tetraacrylate.

In typical embodiments, the hardcoat layer comprises polymerized units of at least one (e.g. non-polar) high Tg monomer, i.e. a (meth)acrylate monomer when reacted to form a homopolymer has a Tg greater than 25° C. The high Tg monomer more typically has a Tg greater than 30° C., 40° C., 50° C., 60° C., 70° C., or 80° C. The (e.g. non-polar) high Tg monomer typically has a Tg no greater than. Mixtures of high Tg monomer may be employed. In some embodiments, the mixture of monomers has a Tg ranging from about 50 to 75° C. In one embodiment, a mixture of hexanediol diacrylate and isobornyl acrylate is utilized.

In some embodiments, the hardcoat layer comprises polymerized units of at least one polar ethylenically unsaturated monomer that comprises one hydroxyl group including hydroxyl groups of various acids such as sulfonic acids, phosphonic acids, and carbonic acids. Representative monomers are depicted as follows. Both the acrylate and/or (meth)acrylate of such comonomers can be employed.

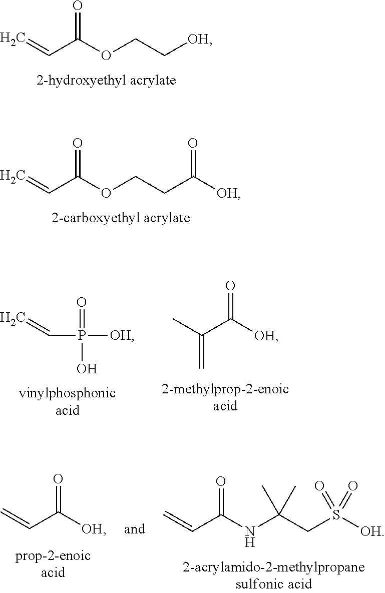

Such monomers can be characterized as polar high Tg ethylenically unsaturated monomers.

In some embodiments, the hardcoat layer further comprises polymerized units of an ethylenically unsaturated compound that comprises siloxane or silyl groups, such as a silicone (meth)acrylate additive. Silicone (meth)acrylate additives generally comprise a polydimethylsiloxane (PDMS) backbone and a terminal (meth)acrylate group. In some embodiments, the silicone (meth)acrylate additive further comprises an alkoxy side chain. Such silicone (meth)acrylate additives are commercially available from various suppliers such as Tego Chemie under the trade designations “TEGO Rad 2100”, “TEGO Rad 2250”, “TEGO Rad 2300”, “TEGO Rad 2500”, and “TEGO Rad 2700”.

Based on NMR analysis “TEGO Rad 2100” is believed to have the following chemical structure:

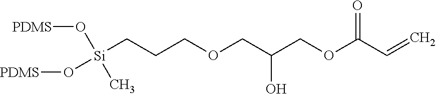

The PDMS backbone in combination with the OSi(CH₃)₃ group is believed to constitute about 50 wt-% of this silicone (meth)acrylate additive; whereas the alkoxy (meth)acrylate side chain is believed to constitute the remaining 50 wt-%.

The silicone (meth)acrylate additive is typically added to the hardcoat composition at a concentration of at least about 0.10, 0.20, 0.30, 0.40, or 0.50 wt. % solids of the organic component of the hardcoat composition to as much as 5 wt. %, 10 wt. % or 20 wt. % solids.

When such silicone (meth)acrylate additives are present on an exposed surface, such additives can reduce the tendency of lint to be attracted to the surface, as described in WO2009/029438. However, when such silicone (meth)acrylate additive are present in a hardcoat layer disposed between an organic polymeric film and (e.g. diamond-like glass) siliceous layer, it is surmised that the silicone or silyl group improves bonding with the siliceous layer.

The hardcoat layer may optionally comprise surface modified inorganic oxide particles that add mechanical strength and durability to the resultant coating. The particles are typically substantially spherical in shape and relatively uniform in size. The particles can have a substantially monodisperse size distribution or a polymodal distribution obtained by blending two or more substantially monodisperse distributions. The inorganic oxide particles are typically non-aggregated (substantially discrete), as aggregation can result in precipitation of the inorganic oxide particles or gelation of the hardcoat.

The size of inorganic oxide particles is chosen to avoid significant visible light scattering. The hard coat composition generally comprises a significant amount of surface modified inorganic oxide nanoparticles having an average (e.g. unassociated) primary particle size or associated particle size of at least 20, 30, 40 or 50 nm and no greater than about 150 nm. The total concentration of inorganic oxide nanoparticles is typically less than 30 wt. % solids of the total solids of the hardcoat. In some embodiments, the total concentration of inorganic oxide nanoparticles is less than 25, 20, 15, 10, 5, or 1 wt. % solids of the total solids of the hardcoat.

In some embodiments, the hardcoat composition may optionally comprise up to about 10 wt. % solids of smaller nanoparticles. Such inorganic oxide nanoparticles typically having an average (e.g. unassociated) primary particle size or associated particle size of at least 1 nm or 5 nm and no greater than 50, 40, or 30 nm.

The average particle size of the inorganic oxide particles can be measured using transmission electron microscopy to count the number of inorganic oxide particles of a given diameter. The inorganic oxide particles can consist essentially of or consist of a single oxide such as silica, or can comprise a combination of oxides, or a core of an oxide of one type (or a core of a material other than a metal oxide) on which is deposited an oxide of another type. Silica is a common inorganic particle utilized in hardcoat compositions. The inorganic oxide particles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid).

Aqueous colloidal silicas dispersions are commercially available from Nalco Chemical Co., Naperville, Ill. under the trade designation “Nalco Collodial Silicas” such as products 1040, 1042, 1050, 1060, 2327, 2329, and 2329K or Nissan Chemical America Corporation, Houston, Tex. under the trade name Snowtex™. Organic dispersions of colloidal silicas are commercially available from Nissan Chemical under the trade name Organosilicasol™. Suitable fumed silicas include for example, products commercially available from Evonik DeGussa Corp., (Parsippany, N.J.) under the trade designation, “Aerosil series OX-50”, as well as product numbers -130, -150, and -200. Fumed silicas are also commercially available from Cabot Corp., Tuscola, Ill., under the trade designations CAB-O-SPERSE 2095”, “CAB-O-SPERSE A105”, and “CAB-O-SIL M5”.

It may be desirable to employ a mixture of inorganic oxide particle types to optimize an optical property, material property, or to lower that total composition cost.

As an alternative to or in combination with silica the hardcoat may comprise various high refractive index inorganic nanoparticles. Such nanoparticles have a refractive index of at least 1.60, 1.65, 1.70, 1.75, 1.80, 1.85, 1.90, 1.95, 2.00 or higher. High refractive index inorganic nanoparticles include for example zirconia (“ZrO₂”), titania (“TiO₂”), antimony oxides, alumina, tin oxides, alone or in combination. Mixed metal oxide may also be employed.

Zirconia for use in the high refractive index layer are available from Nalco Chemical Co. under the trade designation “Nalco OOSSOO8”, Buhler AG Uzwil, Switzerland under the trade designation “Buhler zirconia Z-WO sol” and Nissan Chemical America Corporation under the trade name NanoUse ZR™. A nanoparticle dispersion that comprises a mixture of tin oxide and zirconia covered by antimony oxide (RI˜1.9) is commercially available from Nissan Chemical America Corporation under the trade designation “HX-05M5”. A tin oxide nanoparticle dispersion (RI˜2.0) is commercially available from Nissan Chemicals Corp. under the trade designation “CX-S401M”. Zirconia nanoparticles can also be prepared such as described in U.S. Pat. Nos. 7,241,437 and 6,376,590.

The inorganic nanoparticles of the hardcoat are preferably treated with a surface treatment agent. Surface-treating the nano-sized particles can provide a stable dispersion in the polymeric resin. Preferably, the surface-treatment stabilizes the nanoparticles so that the particles will be well dispersed in the polymerizable resin and results in a substantially homogeneous composition. Furthermore, the nanoparticles can be modified over at least a portion of their surface with a surface treatment agent so that the stabilized particle can copolymerize or react with the polymerizable resin during curing. The incorporation of surface modified inorganic particles is amenable to covalent bonding of the particles to the free-radically polymerizable organic components, thereby providing a tougher and more homogeneous polymer/particle network.

In general, a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes are preferred for silica and other for siliceous fillers. Silanes and carboxylic acids are preferred for metal oxides such as zirconia. The surface modification can be done either subsequent to mixing with the monomers or after mixing. It is preferred in the case of silanes to react the silanes with the particle or nanoparticle surface before incorporation into the resin. The required amount of surface modifier is dependent upon several factors such as particle size, particle type, modifier molecular weight, and modifier type. In general, it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for from 1-24 hr approximately. Surface treatment agents such as carboxylic acids may not require elevated temperatures or extended time.

In some embodiments, inorganic nanoparticle comprises at least one copolymerizable silane surface treatment. Suitable (meth)acryl organosilanes include for example (meth)acryloy alkoxy silanes such as 3-(methacryloyloxy)propyltrimethoxysilane, 3-acryloylxypropyltrimethoxysilane, 3-(methacryloyloxy)propylmethyldimethoxysilane, 3-(acryloyloxypropyl)methyl dimethoxysilane, 3-(methacryloyloxy)propyldimethylmethoxysilane, and 3-(acryloyloxypropyl) dimethylmethoxysilane. In some embodiments, the (meth)acryl organosilanes can be favored over the acryl silanes. Suitable vinyl silanes include vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, and vinyltris(2-methoxyethoxy)silane.

The inorganic nanoparticle may further comprise various other surface treatments, as known in the art, such as a copolymerizable surface treatment comprising at least one non-volatile monocarboxylic acid having more than six carbon atom or a non-reactive surface treatment comprising a (e.g. polyether) water soluble tail.

The urethane (meth)acrylate oligomer and hardcoat composition is synthesized or selected such that it does not detract from the ability to stretch the film by hand. Thus, the conformable organic base member (e.g. film) further comprising the hardcoat layer has a load at 25% strain/cm film width in the same range as previously described. In some embodiments, the load at 25% strain/cm film width is equal to or less than the load at 25% strain/cm film width of the (e.g. conformable) film alone. The inclusion of the siliceous (e.g. DLG) layer also does not detract from the load at 25% strain/cm film width. Thus, the conformable organic base member (e.g. film) further comprising the hardcoat layer and siliceous (e.g. DLG layer) also has a load at 25% strain/cm film width in the same range as previously described.

The inclusion of the hardcoat layer and DLG can affect the tensile modulus and ultimate tensile strength of the (e.g. conformable) film. These properties can change by 5, 10, 15 or 20 MPa, yet still fall within the ranges previously described.

In some embodiments, the inclusion of the hardcoat layer and siliceous layer (e.g. DLG) does not detract from the tensile strain at break or in other words elongation at break of the (e.g. conformable) film. Thus, the tensile stain at break of the film further comprising these layers in the same range as previously described.

In other embodiments, the inclusion of the hardcoat layer and siliceous layer (e.g. DLG) can affect the tensile strain at break or in other words elongation at break. For example, the tensile strain at break can be reduced from 410% to 280% or from 200% to 110%. Thus, the reduction in elongation relative to the conformable film alone can be at least 10, 20, 30, 40 or 50%. However, since the film is typically only stretched 25%, this reduction in elongation typically does not affect the intended end use of the film. In favored embodiments, the tensile strain at break of the (e.g. conformable) film further comprising the siliceous layer (e.g. DLG) is at least 50%, 75%, or 100%, or in other words 2×, 3×, or 4× the amount of stretch intended during use of the film.

In some embodiments, the hardcoat comprises a photoinitiator. Examples include chlorotriazines, benzoin, benzoin alkyl ethers, di-ketones, phenones, and the like. Commercially available photoinitiators include those available commercially from Ciba Geigy under the trade designations Daracur™ 1173, Darocur™ 4265, Irgacure™ 651, Irgacure™ 184, Irgacure™ 1800, Irgacure™ 369, Irgacure™ 1700, Irgacure™ 907, Irgacure™ 819 and from Aceto Corp. (Lake Success, N.Y.) under the trade designations UVI-6976 and UVI-6992. Phenyl-[p-(2-hydroxytetradecyloxy)phenyl]iodonium hexafluoroantomonate is a photoinitiator commercially available from Gelest (Tullytown, Pa.). Phosphine oxide derivatives include Lucirin™ TPO, which is 2,4,6-trimethylbenzoy diphenyl phosphine oxide, available from BASF (Charlotte, N.C.). A difunctional alpha hydroxylketone photoiniators is commercially available from Lambertis USA under the trade designation “ESACURE ONE”. Other useful photoinitiators are known in the art. A photoinitiator can be used at a concentration of about 0.1 to 10 weight percent or about 0.1 to 5 weight percent based on the organic portion of the formulation (phr).

The hardcoat layer can be cured in an inert atmosphere. In some embodiments, the hardcoat layer can be cured with an ultraviolet (UV) light source under a nitrogen blanket.

The polymerizable hardcoat compositions can be formed by dissolving the free-radically polymerizable material(s) in a compatible organic solvent and then combined with the nanoparticle dispersion at a concentration of about 50 to 70 percent solids. A single or blend of the previously described organic solvent solvents can be employed.

The hardcoat composition can be applied as single or multiple layers to a (e.g. film) substrate using conventional film application techniques. Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature. Although it is usually convenient for the substrate to be in the form of a roll of continuous web, the coatings may be applied to individual sheets.

The hardcoat composition is dried in an oven to remove the solvent and then cured for example by exposure to ultraviolet radiation using an H-bulb or other lamp at a desired wavelength, preferably in an inert atmosphere (less than 50 parts per million oxygen). The reaction mechanism causes the free-radically polymerizable materials to crosslink.

The thickness of the cured hardcoat surface layer is typically at least 0.5 microns, 1 micron, or 2 microns. The thickness of the hardcoat layer is generally no greater than 10 microns.

The surface layer 14 is typically formed by applying a curable liquid (e.g. overcoat) composition that includes a siloxane-bondable component over at least a portion of the front surface 14 of the conformable organic polymeric film 15. The coating composition is then cured such that a solid surface layer 14, which is siloxane-bonded to the siliceous layer 13 is formed.

The cured surface layer 14 can be suitable for use as a writing surface (i.e., writable surface) 19 that is cleanable and rewritable.

In some embodiments, the cured surface layer is hydrophilic. As used herein, “hydrophilic” is used to refer to a surface that is wet by aqueous solutions. Surfaces on which drops of water or aqueous solutions exhibit a static water contact angle of less than 50 are referred to as “hydrophilic” per ASTM D7334-08. In contrast, hydrophobic surfaces have a water contact angle of 50° or greater.

In certain embodiments, the hydrophilic surface layer 14 and 19 includes sulfonate-functional groups, phosphate-functional groups, phosphonate-functional groups, phosphonic acid-functional groups, carboxylate-functional groups, or a combination thereof. In certain embodiments, the hydrophilic surface layer 14 and 19 includes sulfonate-functional groups.

In illustrative embodiments, the surface layer 14 is applied in at least a monolayer thickness. As used herein, “at least a monolayer thickness” includes a monolayer or a thicker layer of molecules, covalently bonded (through siloxane bonds) to the underlying facing layer surface and/or primer on the facing layer surface.

In certain embodiments, the surface layer is at least 10 or 15 nm thick. Typically, the surface layer 14 is no greater than 200 nm thick. Such thicknesses can be measured using an ellipsometer such as a Gaertner Scientific Corp Model No. L115C. It will be understood that articles of the disclosure can be made using other thicknesses of the surface layer 14.

In certain embodiments, the hydrophilic overcoat is formed from one or more zwitterionic compounds, such as zwitterionic silanes. Zwitterionic compounds are neutral compounds that have electrical charges of opposite sign within a molecule.

In some embodiments, the surface layer 14 is formed from at least one zwitterionic silane selected from the group of phosphate-functional silanes, phosphonate-functional silanes, phosphonic acid-functional silanes, carboxylate-functional silanes, and sulfonate-functional silanes. Such silanes include groups (e.g., sulfonate group (SO₃⁻)) for imparting desired high hydrophilicity to the surface for providing suitable cleanability. Herein, silanes refer to silicon-containing compounds that have groups capable of forming siloxane bonds with the facing layer. Typically, such groups are alkoxysilane or silanol groups.

Illustrative examples of zwitterionic compounds include those disclosed in U.S. Publication No. 2017/0275495 (Riddle et al.).

In certain embodiments, the zwitterionic compound is a sulfonate-functional zwitterionic compound, such as a zwitterionic sulfonate-functional silane compound. In certain embodiments, the zwitterionic compound comprising sulfonate-functional groups and alkoxysilane groups and/or silanol-functional groups.

In certain embodiments, the zwitterionic sulfonate-functional silane compounds have the following Formula (I) wherein:

(R¹O)ₚ—Si(R²)_{q}—W—N⁺(R³)(R⁴)—(CH₂)ₘ—SO₃⁻ (I)

wherein:
each R¹ is independently a hydrogen, methyl group, or ethyl group;
each R² is independently hydroxyl, (C₁-C₄)alkyl groups, and (C₁-C₄)alkoxy groups, (preferably, a methyl group or an ethyl group);
each R³ and R⁴ is independently a saturated or unsaturated, straight chain, branched, or cyclic organic group (preferably having 20 carbons or less), which may be joined together, optionally with atoms of the group W, to form a ring;
W is an organic linking group;
p is an integer of 1 to 3;
m is an integer of 1 to 10 (preferably, 1 to 4);
q is 0 or 1; and
p+q=3.
The organic linking group W of Formula (I) is preferably selected from saturated or unsaturated, straight chain, branched, or cyclic organic groups. The linking group W is preferably an alkylene group, which may include carbonyl groups, urethane groups, urea groups, heteroatoms such as oxygen, nitrogen, and sulfur, and combinations thereof. Examples of suitable linking groups W include alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups.
Suitable examples of zwitterionic compounds are described in U.S. Pat. No. 5,936,703 (Miyazaki et al.); WO 2007/146680 (Schlenoff); WO 2009/119690 (Yamazaki et al.), and US2014/060583; and include the following zwitterionic functional groups (—W—N⁺(R³)(R⁴)—(CH₂)ₘSO₃⁻):

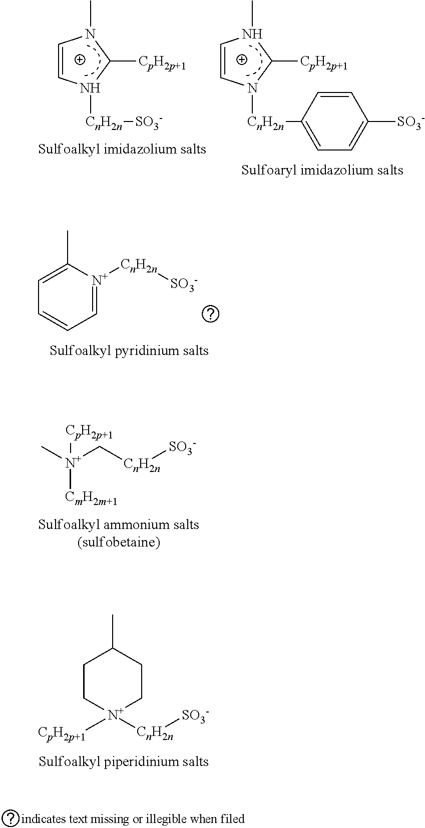

In certain embodiments, the sulfonate-functional silane compounds used in making surface layer 14 have the following Formula (II) wherein:

(R¹O)ₚ—Si(R²)_{q}—CH₂CH₂CH₂—N⁺(CH₃)₂—(CH₂)ₘSO₃⁻ (II)
wherein:
each R¹ is independently a hydrogen, methyl group, or ethyl group;
each R² is independently hydroxyl, (C₁-C₄)alkyl groups, and (C₁-C₄)alkoxy groups, (preferably, a methyl group or an ethyl group);
p is an integer of 1 to 3;
m is an integer of 1 to 10 (preferably, 1 to 4);
q is 0 or 1; and
p+q=3.
Suitable examples of zwitterionic compounds of Formula (II) are described in U.S. Pat. No. 5,936,703 (Miyazaki et al.), including, for example:
   (CH₃O)₃Si—CH₂CH₂CH₂—N⁺(CH₃)₂—CH₂CH₂CH₂—SO₃⁻; and
   (CH₃CH₂O)₂Si(CH₃)—CH₂CH₂CH₂—N⁺(CH₃)₂—CH₂CH₂CH₂—SO₃⁻.
Other examples of suitable zwitterionic compounds, which can be made using standard techniques known to those skilled in the art, include the following:

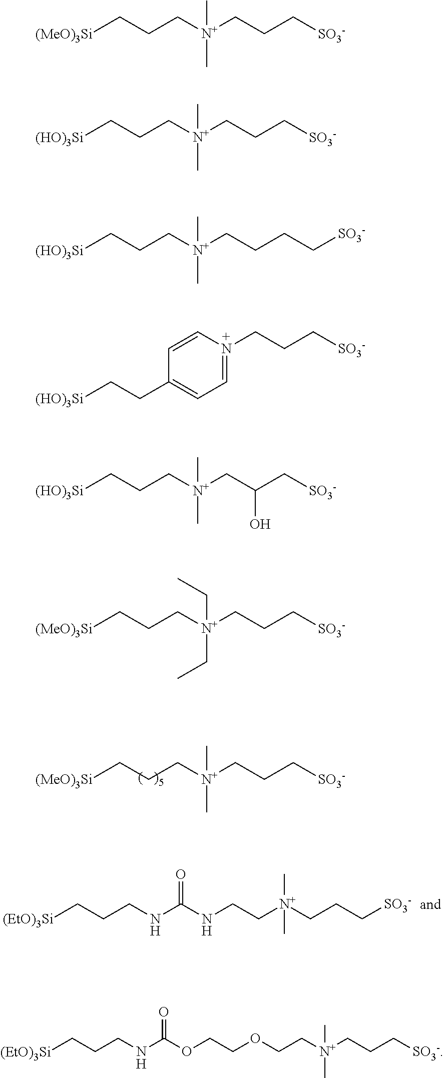

Phosphate-functional zwitterionic compounds can also be utilized.

A coating composition for making surface layer 14 typically includes (e.g. sulfonate-functional) zwitterionic compound(s) in an amount of at least 0.1 wt. %, and often at least 1 wt. %, based on the total weight of the coating composition (including water and/or other solvent(s). The coating composition typically includes (e.g. sulfonate-functional) zwitterionic compound(s) in an amount no greater than 20, 15, 10, or 5 wt. %, based on the total weight of the coating composition. Generally, for monolayer coating thicknesses, relatively dilute coating compositions are used. Alternatively, relatively concentrated coating compositions can be used and subsequently rinsed.

The coating composition for making surface layer 14 typically includes alcohol, water, or hydroalcoholic solutions (i.e., alcohol and/or water). Typically, such alcohols are lower alcohols (e.g., (C1-C8)alcohols, and more typically (C1-C4)alcohols), such as methanol, ethanol, propanol, 2-propanol, etc. Preferably, sulfonate-functional coating compositions are aqueous solutions. As it is used herein, the term “aqueous solution” refers to solutions containing water. Such solutions may employ water as the only solvent or they may employ combinations of water and organic solvents such as alcohol and acetone. Organic solvents may also be included in the hydrophilic treatment compositions so as to improve their freeze-thaw stability. Typically, the solvents are present in an amount up to 50 wt. % of the compositions and preferably in the range of 5 to 50 wt. % of the compositions.

The coating composition can be acidic, basic, or neutral. The performance durability of the coatings can be affected by pH. For example, coating compositions containing sulfonate-functional zwitterionic compounds are preferably neutral.

The coating composition may be provided in a variety of viscosities. Thus, for example, the viscosity may vary from a water-like thinness to a paste-like heaviness. They may also be provided in the form of gels.

Additionally, a variety of other ingredients may be incorporated in the coating compositions for making surface layer 14. Thus, for example, conventional surfactants, cationic, anionic, or nonionic surfactants can be used. Detergents and wetting agents can also be used. At least one of a water soluble alkali metal silicate, a tetraalkoxysilane monomer, a tetraalkoxysilane oligomer, and an inorganic silica sol can be used if desired. In certain embodiments, the coating further comprises a water soluble alkali metal silicate, particularly lithium silicate. In certain embodiments, however, the compositions used to form the surface layer 14 do not include surfactants.

In one embodiment, the method for making an embodied article comprises:

(a) providing a (e.g. flexible and/or conformable) organic polymeric (e.g. film) having a (e.g. front) surface (b) providing a hardcoat layer on the front surface by (b1) applying a hardcoat composition and (b2) curing the hardcoat composition; (c) depositing a siliceous (e.g. DLG) thin film layer onto the hardcoat composition; (d) providing a surface layer by (d1) applying the previously described zwitterionic silane compound(s) to at least a portion of the siliceous layer; and (d2) drying the coating such that the silyl group of the silane compounds forms a siloxane bond with the siliceous (e.g. DLG) thin film layer.

The surface layer coating compositions are preferably coated on a body member using conventional techniques, such as bar, roll, curtain, rotogravure, spray, or dip coating techniques. The preferred methods include bar and roll coating, or air knife coating to adjust thickness.

Once coated, the coating composition is typically dried at temperatures of 20° C. to 150° C. in a recirculating oven. An inert gas may be circulated. The temperature may be increased further to speed the drying process, but care must be exercised to avoid damage to the substrate.

Such hydrophilic overcoat provides a cleanable surface such that the articles described herein can be readily cleaned, e.g., by simply wiping with a dry cloth, paper towel, etc., or in some instances, by wiping with a cloth, paper towel, etc., using water.

For instance, the surface layer can be readily written on, then easily cleaned. Significantly, even permanent marker writing can be easily removed with wiping, preferably after first applying water and/or water vapor (e.g., by breathing). Typically, methods of the present disclosure include removing permanent marker writing from the surface by simply applying water (e.g., tap water at room temperature) and/or water vapor (e.g., a person's breath) and wiping. As used herein, “wiping” refers to gentle wiping, typically by hand, with for example, a tissue, paper towel, or a cloth, without significant pressure (e.g., generally, no more than 350 grams) for one or more strokes or rubs (typically, only a few are needed).

The hardcoat layer and siliceous (e.g. DLG) layer can improve the durability of the cleanable surface layer 14. In some embodiments, the cleanable surface layer exhibits 90% or 100% permanent marker removability (according to the test method described in the examples) after 1000, 2000, 3000, or 4000 linear Taber abrader cycles.

In some embodiments, the surface layer is easily cleaned, but not necessarily “writable”. Illustrative applications where easy cleanability is desired include windows, electronic device screens, work surfaces, appliances, door and wall surfaces, signs, etc. In some embodiments, the film is useful as a graphic film or a protection film. Protection films can be applied to automobiles to protect the paint.

Protection films can also be applied to (e.g. vehicle) sensors. Examples of various types of sensors used to detect objects in the surroundings may include lasers or LIDAR (light detection and ranging), sonar, radar, cameras, and other devices which have the ability to scan and record data from the vehicle's surroundings. Such scans will necessarily be initiated or received through an exterior facing element. The exterior facing element may be part of the scanning sensor itself or may be an additional part of the vehicle sensor system that shields or protects more fragile parts. Example of such exterior facing elements include a windshield (if a sensor is placed behind the windshield), a headlight (if sensor is placed behind the headlight), a protective housing and the surface of a camera lens.

The exterior facing element has a surface (the exterior surface) that is exposed to elements of the outdoor environment, for example temperature, water, other weather, dirt and debris. Any of these elements can interfere with the exterior facing element and can compromise the scan going out or the data coming in to the vehicle sensor system.

In one embodiment, a vehicle sensor is described comprising an exterior surface wherein the exterior surface comprises the protection film described herein.

In some embodiments, the article is a dry erase article or component thereof. The dry erase article can further comprise other optional components such as frames, means for storing materials and tools such as writing instruments, erasers, cloths, note paper, etc., handles for carrying, protective covers, means for hanging on vertical surfaces, easels, etc.

Other articles that include writable surfaces include dry erase boards, file folders, notebooks, binders etc. where effective writability coupled with later easy removal of the writing is desired.

In some embodiments, cleaning the surface, e.g., erasing the (e.g. permanent) ink, is facilitated by using a cleaner composition, preferably a Cleaning and Protecting Composition as described in 80575US002; incorporated herein by reference. Such cleaner composition can replenish the properties of the surface layer.

The cleaner compositions can be dispersions or solutions. They typically include a hydrophilic silane, a surfactant, and water.

Such composition can be applied to a clean surface, a surface that is soiled, a surface that includes irregularities and defects, a previously cleaned surface, and combinations thereof, and can be used repeatedly. Typically, such composition is applied to a surface of an writable and cleanable article as described herein wherein the hydrophilic overcoat has an at least partially depleted hydrophilic surface. Such depletion adversely impacts the cleanability of the surface, and may even adversely impact the writability of the surface. Use of the cleaning and protecting composition on a writable surface increases the amount of hydrophilic silane on the surface and increases the hydrophilicity of the surface, thereby replenishing the hydrophilic overcoat and restoring cleanability, and may even restore the writability, of the surface.

Such composition also preferably imparts a sufficient hydrophilic property to a surface such that when the surface is subsequently marked with a permanent marker, the mark can be substantially removed, or even completely removed, from the surface with at least one of water (e.g., tap water at ambient temperature), water vapor (e.g., an individual's breath), wiping (e.g., up to a few gentle strokes with a tissue, paper towel, cloth), a cleaning composition, and combinations thereof (e.g., by spraying the surface and the mark with water and then wiping).

In certain embodiments, the cleaning and protecting composition preferably includes an amount of hydrophilic silane and an amount of surfactant such that ratio of the weight of the hydrophilic silane to the weight of the surfactant in the composition is at least 1:1, at least 1:2, at least 1:3, at least 1:10, at least 1:40, or at least 1:400. That is, in such compositions the amount of surfactant is equal to or greater than the amount of hydrophilic silane. In certain embodiments, a cleaning and protecting composition preferably includes an amount of hydrophilic silane and an amount of surfactant such that ratio of the weight of the hydrophilic silane to the weight of the surfactant in the composition is from 1:2 to 1:100, or even from 1:3 to at 1:20. This composition is typically more useful on a surface that is regularly cleaned, which is not subject to build-up of contaminants, so protection is not critical, but repeated use can provide protection and make the surface easier to clean.

The cleaning and protecting composition can be acidic, basic, or neutral. The pH of the composition can be altered to achieve the desired pH using any suitable acid or base as is known in the art, including, e.g., organic acids and inorganic acids, or carbonates, such as potassium or sodium carbonate. Compositions that include sulfonate-functional zwitterionic compounds have a pH of from 5 to 8, are neutral, or even are at their isoelectric point.

The cleaning and protecting composition can be provided in a variety of forms including, e.g., as a concentrate that is diluted before use (e.g., with water, a solvent or an aqueous-based composition that includes an organic solvent) or as a ready-to-use composition, a liquid, a paste, a foam, a foaming liquid, a gel, and a gelling liquid. The multi-functional composition has a viscosity suitable for its intended use or application including, e.g., a viscosity ranging from a water-like thinness to a paste-like heaviness at 22° C. (72° F.).

In certain embodiments, useful cleaning and protecting compositions include no greater than 2 wt. % solids, or even no greater than 1 wt. % solids, and often at least 0.05 wt. % solids. Solids typically means the components other than water.

The cleaning and protection composition typically comprises a hydrophilic silane. Suitable hydrophilic silanes are preferably water soluble, and in some embodiments, suitable hydrophilic silanes are nonpolymeric compounds. They are siloxane-bondable, i.e., capable of forming siloxane bonds to the overcoat, facing layer, and/or optional primer layer.

Useful hydrophilic silanes include, e.g., individual molecules, oligomers (typically less than 100 repeat units, and often only a few repeat units) (e.g., monodisperse oligomers and polydisperse oligomers), and combinations thereof, and preferably have a number average molecular weight no greater than (i.e., up to) 5000 grams per mole (g/mole), no greater than 3000 g/mole, no greater than 1500 g/mole, no greater than 1000 g/mole or even no greater than 500 g/mole. The hydrophilic silane optionally is a reaction product of at least two hydrophilic silane molecules.

These typically are selected to provide protectant properties to a composition of the present disclosure. The hydrophilic silane can be any one of a variety of different classes of hydrophilic silanes including, e.g., zwitterionic silanes, non-zwitterionic silanes (e.g., cationic silanes, anionic silanes and nonionic silanes), silanes that include functional groups (e.g., functional groups attached directly to a silicon molecule, functional groups attached to another molecule on the silane compound, and combinations thereof), and combinations thereof. Useful functional groups include, e.g., alkoxysilane groups, siloxy groups (e.g., silanol), hydroxyl groups, sulfonate groups, phosphonate groups, carboxylate groups, gluconamide groups, sugar groups, polyvinyl alcohol groups, quaternary ammonium groups, halogens (e.g., chlorine and bromine), sulfur groups (e.g., mercaptans and xanthates), color-imparting agents (e.g., ultraviolet agents (e.g., diazo groups) and peroxide groups), click reactive groups, bioactive groups (e.g., biotin), and combinations thereof.

Examples of suitable classes of hydrophilic silanes that include functional groups include sulfonate-functional zwitterionic silanes, sulfonate-functional non-zwitterionic silanes (e.g., sulfonated anionic silanes, sulfonated nonionic silanes, and sulfonated cationic silanes), hydroxyl sulfonate silanes, phosphonate silanes (e.g., 3-(trihydroxysilyl)propyl methyl-phosphonate monosodium salt), carboxylate silanes, gluconamide silanes, polyhydroxyl alkyl silanes, polyhydroxyl aryl silanes, hydroxyl polyethyleneoxide silanes, polyethyleneoxide silanes, and combinations thereof.

Useful sulfonate-functional zwitterionic silanes are those of Formulas (I) and (II) as described above for the overcoat of the writable and cleanable article.

A useful class of sulfonate-functional non-zwitterionic silanes has the following Formula (III):

[(MO)(Qₙ)Si(XCH₂SO₃⁻)₃₋ₙ]Y_{2/nr}^{+r} (III)

wherein:

each Q is independently selected from hydroxyl, alkyl groups containing from 1 to 4 carbon atoms, and alkoxy groups containing from 1 to 4 carbon atoms;

M is selected from hydrogen, alkali metals, and organic cations of strong organic bases having an average molecular weight of less than 150 and a pKa of greater than 11;

X is an organic linking group;

Y is selected from hydrogen, alkaline earth metals, organic cations of protonated weak bases having an average molecular weight of less than 200 and a pKa of less than 11, alkali metals, and organic cations of strong organic bases having an average molecular weight of less than 150 and a pKa of greater than 11, provided that when Y is hydrogen, alkaline earth metals or an organic cation of a protonated weak base, M is hydrogen;

r is equal to the valence of Y; and

n is 1 or 2.

Preferred non-zwitterionic silanes of Formula (III) include alkoxysilane compounds in which Q is an alkoxy group containing from 1 to 4 carbon atoms.

The silanes of Formula (III) preferably include is at least 30 wt. %, at least 40 wt. %, or even from 45 wt. % to 55 wt. %, and no greater than 15 wt. %, based on the weight of the compound in the water-free acid form.

Useful organic linking groups X of Formula (III) include, e.g., alkylenes, cycloalkylenes, alkyl-substituted cycloalkylenes, hydroxy-substituted alkylenes, hydroxy-substituted mono-oxa alkylenes, divalent hydrocarbons having mono-oxa backbone substitution, divalent hydrocarbons having mono-thia backbone substitution, divalent hydrocarbons having monooxo-thia backbone substitution, divalent hydrocarbons having dioxo-thia backbone substitution, arylenes, arylalkylenes, alkylarylenes, and substituted alkylarylens.

Examples of useful Y groups of Formula (III) include 4-aminopyridine, 2-methoxyethylamine, benzylamine, 2,4-dimethylimidazole, and 3-[2-ethoxy(2-ethoxyethoxy)]propylamine, N(CH₃)₄, and ⁺N(CH₂CH₃)₄.

Suitable sulfonate-functional non-zwitterionic silanes of Formula (III) include, e.g., (HO)₃Si—CH₂CH₂CH₂—O—CH₂—CH(OH)—CH₂SO₃—H⁺; (HO)₃Si—CH₂CH(OH)—CH₂SO₃—H⁺; (HO)₃Si—CH₂CH₂CH₂SO₃—H⁺; (HO)₃Si—C₆H₄—CH₂CH₂SO₃—H⁺; (HO)₂Si—[CH₂CH₂SO₃H⁺]₂; (HO)—Si(CH₃)₂—CH₂CH₂SO₃—H⁺; (NaO)(HO)₂Si—CH₂CH₂CH₂—O—CH₂—CH(OH)—CH₂SO₃—Na⁺; and (HO)₃Si—CH₂CH₂SO₃—K⁺ and those sulfonate-functional non-zwitterionic silanes of Formula (III) described in U.S. Pat. No. 4,152,165 (Langager et al.) and U.S. Pat. No. 4,338,377 (Beck et al).

The cleaning and protecting composition preferably includes at least 0.0001 wt. %, at least 0.001 wt. %, or in certain embodiments at least 0.005 wt. %, at least 0.01 wt. %, or at least 0.05 wt. %, hydrophilic silane. A cleaning and protecting composition preferably includes up to 10 wt. %, or in certain embodiment no greater than 3 wt. %, no greater than 2 wt. %, no greater than 1.5 wt. %, no greater than 1 wt. %, no greater than 0.75 wt. %, or even no greater than 0.5 wt. %, hydrophilic silane. The hydrophilic silane optionally is provided in a concentrated form that can be diluted to achieve the percent by weight hydrophilic silane set forth above.

The cleaning and protection composition typically comprises a surfactant. Suitable surfactants include, e.g., anionic, nonionic, cationic, and amphoteric surfactants, and combinations thereof. These can provide cleaning properties, wetting properties, or both to a composition of the present disclosure.

The cleaning and protecting composition may contain more than one surfactant. One or more surfactants is typically selected to function as a cleaning agent. One or more surfactants is typically selected to function as a wetting agent. The cleaning agent(s) can be a detergents, foaming agents, dispersants, emulsifiers, or combinations thereof. The surfactants in such cleaning agents typically include both a hydrophilic portion that is anionic, cationic, amphoteric, quaternary amino, or zwitterionic, and a hydrophobic portion that includes a hydrocarbon chain, fluorocarbon chain, siloxane chain, or combinations thereof. The wetting agent(s) can be selected from a wide variety of materials that lowers the surface tension of the composition. Such wetting agents typically include a non-ionic surfactant, hydrotrope, hydrophilic monomer or polymer, or combinations thereof.

In certain embodiments of a cleaning and protecting composition, one surfactant can be an anionic surfactant and one can be a nonionic surfactant.

Useful anionic surfactants include surfactants having a molecular structure that includes: (1) at least one hydrophobic moiety (e.g., an alkyl group having from 6 to 20 carbon atoms in a chain, alkylaryl group, alkenyl group, and combinations thereof), (2) at least one anionic group (e.g., sulfate, sulfonate, phosphate, polyoxyethylene sulfate, polyoxyethylene sulfonate, polyoxyethylene phosphate, and combinations thereof), (3) salts of such anionic groups (e.g., alkali metal salts, ammonium salts, tertiary amino salts, and combinations thereof), and combinations thereof.

Useful anionic surfactants include, e.g., fatty acid salts (e.g., sodium stearate and sodium dodecanoate), salts of carboxylates (e.g., alkylcarboxylates (carboxylic acid salts) and polyalkoxycarboxylates, alcohol ethoxylate carboxylates, and nonylphenol ethoxylate carboxylates); salts of sulfonates (e.g., alkylsulfonates (alpha-olefinsulfonate), alkylbenzenesulfonates (e.g., sodium dodecylbenzenesulfonate), alkylarylsulfonates (e.g., sodium alkylarylsulfonate), and sulfonated fatty acid esters); salts of sulfates (e.g., sulfated alcohols (e.g., fatty alcohol sulfates, e.g., sodium lauryl sulfate), salts of sulfated alcohol ethoxylates, salts of sulfated alkylphenols, salts of alkylsulfates (e.g., sodium dodecyl sulfate), sulfosuccinates, and alkylether sulfates), aliphatic soap, fluorosurfactants, anionic silicone surfactants, and combinations thereof.

Suitable commercially available anionic surfactants include sodium lauryl sulfate surfactants available under the trade designations TEXAPON L-100 from Henkel Inc. (Wilmington, Del.) and STEPANOL WA-EXTRA from Stepan Chemical Co. (Northfield, Ill.), sodium lauryl ether sulfate surfactants available under the POLYSTEP B-12 trade designation from Stepan Chemical Co., ammonium lauryl sulfate surfactants available under the trade designation STANDAPOL A from Henkel Inc., sodium dodecyl benzene sulfonate surfactants available under the trade designation SIPONATE DS-10 from Rhone-Poulenc, Inc. (Cranberry, N.J.), decyl(sulfophenoxy)benzenesulfonic acid disodium salt available under the trade designation DOWFAX C10L from The Dow Chemical Company (Midland, Mich.).

Useful amphoteric surfactants include, e.g., amphoteric betaines (e.g., cocoamidopropyl betaine), amphoteric sultaines (cocoamidopropyl hydroxysultaine and cocoamidopropyl dimethyl sultaine), amphoteric imidazolines, and combinations thereof. A useful cocoamidopropyl dimethyl sultaine is commercially available under the LONZAINE CS trade designation from Lonza Group Ltd. (Basel, Switzerland). Useful coconut-based alkanolamide surfactants are commercially available from Mona Chemicals under the MONAMID 150-ADD trade designation). Other useful commercially available amphoteric surfactants include, e.g., caprylic glycinate (an example of which is available under the REWOTERIC AMV trade designation from Witco Corp.) and capryloamphodipropionate (an example of which is available under the AMPHOTERGE KJ-2 trade designation from Lonza Group Ltd.

Examples of useful nonionic surfactants include polyoxyethylene glycol ethers (e.g., octaethylene glycol monododecyl ether, pentaethylene monododecyl ether, poly-oxyethylenedodecyl ether, polyoxyethylenehexadecyl ether), polyoxyethylene glycol alkylphenol ethers (e.g., polyoxyethylene glycol octylphenol ether and polyoxyethylene glycol nonylphenol ether), polyoxyethylene sorbitan monoleate ether, polyoxyethylenelauryl ether, polyoxypropylene glycol alkyl ethers, glucoside alkyl ethers (e.g., decyl glucoside, lauryl glucoside, and octyl glucoside), glycerol alkyl esters, polyoxyethylene glycol sorbitan alkyl esters, monodecanoyl sucrose, cocamide, dodecyldimethylamine oxide, alkoxylated alcohol nonionic surfactants (e.g., ethoxylated alcohol, propoxylated alcohol, and ethoxylated-propoxylated alcohol). Useful nonionic surfactants include alkoxylated alcohol commercially available under the trade designations NEODOL 23-3 and NEODOL 23-5 from Shell Chemical LP (Houston, Tex.) and the trade designation IGEPAL CO-630 from Rhone-Poulenc, lauramine oxide commercially available under the BARLOX LF trade designation from Lonza Group Ltd. (Basel, Switzerland), and alkyl phenol ethoxylates and ethoxylated vegetable oils commercially available under the trade designation EMULPHOR EL-719 from GAF Corp. (Frankfort, Germany).

Examples of useful cationic surfactants include dodecyl ammonium chloride, dodecyl ammonium bromide, dodecyl trimethyl ammonium bromide, dodecyl pyridinium chloride, dodecyl pyridinium bromide, hexadecyl trimethyl ammonium bromide, cationic quaternary amines, and combinations thereof.

Other useful surfactants are disclosed, e.g., in U.S. Pat. No. 6,040,053 (Scholz et al). The surfactant preferably is present in a cleaning and protecting composition in an amount sufficient to reduce the surface tension of the composition relative to the composition without the surfactant and to clean the surface. A cleaning and protecting composition preferably includes at least 0.02 wt. %, or at least 0.03 wt. %, or at least 0.05 wt. %, or at least 10 wt. %, surfactant. A cleaning and protecting composition preferably includes no greater than 0.4 wt. %, or no greater than 0.25 wt. %, surfactant. In certain embodiments, a cleaning and protecting composition preferably includes from 0.05 wt. % to 0.2 wt. %, or from 0.07 wt. % to 0.15 wt. %, surfactant.

The amount of water present in a cleaning and protecting composition varies depending upon the purpose and form of the composition. A cleaning and protecting composition can be provided in a variety of forms including, e.g., as a concentrate that can be used as is, a concentrate that is diluted prior to use, and as a ready-to-use composition. Useful concentrate compositions include at least 60 wt. %, at least 65 wt. %, or at least 70 wt. %, water. Useful concentrate compositions include no greater than 97 wt. %, no greater than 95 wt. %, or no greater than 90 wt. %. In certain embodiments, useful concentrate compositions include from 75 wt. % to 97 wt. %, or even from 75 wt. % to 95 wt. %.

Useful ready-to-use compositions include at least 70 wt. %, at least 80 wt. %, at least 90 wt. %, at least 95 wt. % or greater water.

The cleaning and protecting composition optionally includes one or more silicates, polyalkoxy silanes, or combinations thereof. These components can provide cleaning capability (e.g., as a result of increasing the pH of the composition) and/or provide protection (e.g., as a result of crosslinking).

Other optional ingredients include organic solvent and thickening agents.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.
These abbreviations are used in the following examples: g=gram, hr=hour, kg=kilograms, min=minutes, mol=mole; cm=centimeter, mm=millimeter, mL=milliliter, L=liter, MPa=megaPascals, and wt=weight.

TABLE 1
Materials.

| Abbreviation | | |
|---|---|---|
| and/or | | |
| Trade name | Description | Source |
| HDDA | hexanediol diacrylate | Sartomer Americas, |
| SR238 | Tg = 43° C. | Exton, PA, USA |
| CN 991 | Aliphatic polyurethane | Sartomer Americas, |
| | diacrylate Tg = 27° C. | Exton, PA, USA |
| IBOA | Isobomyl Acrylate - | Sartomer Americas, |
| SR 506 | Tg = 88° C. | Exton, PA, USA |
| SR 217 | Cycloaliphatic acrylate | Sartomer Americas, |
| | High Tg (specific Tg value | Exton, PA, USA |
| | not reported) | |
| SR-611 | Alkoxylated | |
| | tetrahydrofurfuryl acrylate | |
| | Tg = −51° C. | |
| B-CEA | 2-carboxyethyl acrylate | Allnex, Alpharetta, |
| | | GA, USA |
| MEK | Methyl ethyl ketone | Avantor Performance |
| | | Materials, Center |
| | | Valley, PA, USA |
| Tegorad 2100 | Silicone acrylate | Evonik, Parsippany, |
| | surfactant | NJ, USA |
| Irgacure 184 | 1-Hydroxycyclohexyl | IGM Resins, |
| | phenyl ketone | Charlotte, NC, USA |
| | photoinitator | |
| ESACURE | Difuntiomal alpha | A photoinitiator, |
| ONE | hydroxyketone | obtained from |
| | photoinitator | Lamberti USA, |
| | | Conshohocken, |
| | | PA under trade |
| | | designation |
| | | “ESACURE ONE” |
| C-2050 | A polycarbonate diol of | Kuraray Co. Ltd. |
| | about 2000 MW made with | |
| | about a 5:5 ratio of (MPD): | |
| | (HD) obtained as | |
| | “KURARAY POLYOL C-2050” | |
| HEA | Hydroxyethyl acrylate, | Alfa Aesar, Ward |
| | | Hill, MA. |
| Desmodur I | Hexamethylene Diisocyanate | Covestro LLC, |
| (IPDI) | under trade designation | Pittsburgh, PA |
| | “DESMODUR I” equivalent | |
| | weight 111.11, molecular | |
| | weight 222.22 g/mole. | |
| DBTDL | Dibutyltin diacrylate | Sigma- |
| | | AldrichChemical |
| | | Company, St. |
| | | Louis, MO. |
| BHT | 2,6-di-t-butyl-4- | Alfa Aesar, Ward |
| | methylphenol | Hill MA |

### Materials

### Polyurethane Example 1 (PUA1): 4 IPDI/2 C-2050/2 HEA

A 11 three-necked round bottom was charged with 520.84 g C-2050 (0.5286 eq, 984.2 OH EW) heated to about 45° C., 117.46 g IPDI(1.0457 eq), 0.280 g BHT(400 ppm), and 0.175 DBTDL (250 ppm). The reaction was heated under dry air to an internal setpoint of 105° C. (temperature reached at about 20 min). At 1 h 23 min, 62.30 g HEA (0.5365 eq, 116.12 MW, a 1.5% excess) was added via an addition funnel at a steady rate over about 20 min. The reaction was heated for about 2h more at 105° C., then an aliquot was checked by FTIR and found to have no —NCO peak at 2265 cm⁻¹ and the product was isolated as a clear thick material.

### Test Methods

### Abrasion

Abrasion of the samples was tested cross web to the coating direction using a Taber model 5800 Heavy Duty Linear Abraser (obtained from Taber Industries, North Tonawanda, N.Y.). The stylus oscillated at 60 cycles/min. The stylus was a cylinder with a flat base and a diameter of 5 cm. The abrasive material used for this test was a scouring pad obtained from 3M, St. Paul, Minn. under trade designation “SCOTCHBRITE #64660 Durable Flex Hand Pad”.

3 cm squares were cut from the pads and adhered to the base of the stylus using permanent adhesive tape (obtained from 3M Company, St. Paul, Minn., under trade designation “3M SCOTCH PERMANENT ADHESIVE TRANSFER TAPE”). A single sample was tested for each example with a total weight of 0.5 kg weight and 10 cycles. After abrasion, the 60 degree gloss of each sample was measured using a Byk micro-tri-gloss meter (available from BYK Gardner, Columbia Md.) at three different points. Higher gloss values indicate better abrasion resistance.

### Maximum Elongation Without Cracking

Samples of the coated 3M™ Wrap Film Series 1080 (G12 Gloss Black) were cut into three 1 cm×12 cm strips. These were applied to the panel at one end with the pressure sensitive adhesive present on the commercially available film. (Alternatively, for evaluating films without a pre-applied adhesive, a lcm (or wider)×10 cm (or longer) strip of 3M 444 double sided tape can be applied to the panel. Then a film (e.g. vinyl) or coated film can be cut into the three 1 cm×12 cm strips, stretched and attached to the double coated tape on the panel.)

The center 5 cm of each strip was stretched to 6.25 cm and adhered to give a 25% stretched sample. The center 5 cm of each strip was stretched to 7.5 cm and adhered to give a 50% stretched sample. The center 5 cm was stretched to 8.75 cm and adhered to give a 75% stretched sample. The rate of stretching was about 2 cm/second. After one hour the samples visually inspected for cracks. The highest amount of stretch in which the sample passed is reported. Thus, 25% means there were no cracks on the 25% stretched sample and that cracks were evident (failed) at 50% stretch.

### EXAMPLES

EX 1-20 coating solutions were prepared by mixing the components as summarized in Table 2, above. Each of the coating solutions also contained 3.19 wt. % of Tego 2100 and 0.96 wt. % of Irgacure 184. The components were mixed with MEK with stirring to produce a 50% solids solution.

The above prepared hardcoat coating solution was coated at 50 wt. % solids on 3M™ Wrap Film Series 1080 (G12 Gloss Black) obtained from 3M Company, St. Paul, Minn. The coating was applied using a #10 wire wound rod (available from R.D. Specialties, Webster N.Y.) and dried at 65° C. for 2 minutes. The coating was then cured using a 500 Watt/in Fusion H bulb (available from Fusion UV Systems, Gaithersburg Md.) at 100% power under nitrogen at 40 feet/minute (12.2 m/min). The cured coating had a thickness of about 5 microns.

The maximum elongation w/o cracking and gloss after abrasion was evaluated as reported in the following Table 2.

TABLE 2

| | | | | | | | | Maximum |
|---|---|---|---|---|---|---|---|---|
| | | | | | | | Gloss | Elongation |
| | PUA | PUA | Monomer | Monomer | Monomer | Monomer | After | w/o |
| Ex. | Type | Amt. | 1 | 1 Amount | 2 | 2 Amount | Abrasion | Cracking |
| 1 | CN 991 | 95.85 | SR 506 | 0.00 | | | 71 | 50 |
| 2 | CN 991 | 79.87 | SR 506 | 15.97 | | | 72 | 25 |
| 3 | CN 991 | 63.90 | SR 506 | 31.95 | | | 59 | 50 |
| 4 | CN 991 | 47.92 | SR 506 | 47.92 | | | 53 | 50 |
| 5 | PUA1 | 95.85 | SR 506 | 0.00 | | | 54 | 75 |
| 6 | PUA1 | 79.87 | SR 506 | 15.97 | | | 46 | 75 |
| 7 | PUA1 | 63.90 | SR 506 | 31.95 | | | 51 | 75 |
| 8 | PUA1 | 47.92 | SR 506 | 47.92 | | | 53 | 75 |
| 9 | CN 991 | 63.90 | SR 506 | 0.00 | SR 238 | 31.95 | 65 | 25 |
| 10 | CN 991 | 63.90 | SR 506 | 7.99 | SR 238 | 23.96 | 61 | 50 |
| 11 | CN 991 | 63.90 | SR 506 | 15.97 | SR 238 | 15.97 | 61 | 50 |
| 12 | CN 991 | 63.90 | SR 506 | 23.96 | SR 238 | 7.99 | 59 | 50 |
| 13 | CN 991 | 63.90 | SR 506 | 31.95 | SR 238 | 0.00 | 60 | 50 |
| 14 | CN 991 | 63.90 | SR 217 | 15.97 | SR 238 | 15.97 | 54 | 50 |
| 15 | PUA1 | 63.90 | SR 506 | 0.00 | SR 238 | 31.95 | 53 | 50 |
| 16 | PUA1 | 63.90 | SR 506 | 15.97 | SR 238 | 15.97 | 51 | 75 |
| 17 | PUA1 | 63.90 | B-CEA | 31.95 | | | 64 | 75 |
| 18 | PUA1 | 63.90 | SR611 | 31.95 | | | 45 | 75 |
| 19 | CN 991 | 63.90 | B-CEA | 31.95 | | | 68 | 50 |
| 20 | CN 991 | 63.90 | SR611 | 31.95 | | | 51 | 50 |
| 21 | CN 991 | 65.2 | SR 506 | 16.4 | SR 238 | 16.4 | | 75 |

### Preparation of Film of Thermoplastic Polyurethane (PUB)

| Designation | Description | Supplier |
|---|---|---|
| FOMREZ-44-111 | Polyester polyol | Chemtura, |
| | | Philadelphia, PA |
| 1,4 Butanediol | Chain extender diol | BASF |
| DESMODUR W | Bis(4-isocyantocyclohexyl) | Bayer, Leverkusen, |
| | methane | Germany |

All the ingredients including 509.7 grams of pre-melted FOMREZ-44-111 (having a melting temperature of 60° C.) at 100° C., 5 grams of IRGANOX-1076, 1.0 grams of T12 dibutyltin dilaurate catalyst, 87.1 grams of 1,4 butanediol, 0.9 grams of glycerol, 394.5 grams of DESMODUR W, 3 grams of TINUVIN-292, and 4.5 grams of TINUVIN-571 were fed separately into the twin-screw extruder. The extruder setup, conditions, and temperature profiles were similar to that described in Example No. 1 and in Table 1 in U.S. Pat. No. 8,551,285. The isocyanate index was NCO/OH=1.01 and hard segment (Desmodur W+1,4 butanediol) was at 48.25%. The hydroxyl group crosslinker was 1.0% based on the total hydroxyl mole %. The resulting aliphatic thermoplastic polyurethane film was extruded as a 150 micrometers thick layer onto a polyester carrier web. The aliphatic thermoplastic polyurethane had a weight average molecular weight Mw of 139,000 g/mole and a Tg of 32° C.

### Tensile Testing of Films

The tensile properties of uncoated films as well as films coated with only the hardcoat and films with the hardcoat and DLG were evaluated.

### Sample Preparation

The hardcoat coating composition of EX. 21 with 2% Esacure One photoinitator and 0.6% Tegorad 2100 was prepared at 35 wt. % solids.

The hardcoat coating composition was applied to four different films using a #12 wire wound rod (available from R.D. Specialties, Webster N.Y.) and dried at 65° C. for 2 minutes. The coating was then cured using a 500 Watt/in Fusion H bulb (available from Fusion UV Systems, Gaithersburg Md.) at 100% power under nitrogen at 40 feet/minute (12.2 m/min). The cured coating had a thickness of about 5 microns.

The four different films were as follows:

1. 5 mil (0.10 mm) primed PET film obtained from 3M Company, St. Paul, Minn., under trade designation SCOTCHPAK”.

2. 8518 vinyl film obtained from 3M Company, St. Paul, Minn.

3. Polyurethane film A (PUA), Scotchguard™ Paint Protection Film Pro Series obtained from 3M Company, St. Paul, Minn.

4. Polyurethane film B (PUB), an aliphatic thermoplastic extruded polyurethane film, as previously described.

A DLG layer was deposited onto the cured hardcoat surface using a 2-step web process. A homebuilt plasma treatment system described in detail in U.S. Pat. No. 5,888,594 (David et al.) was used with some modifications: the width of the drum electrode was increased to 42.5 inches (108 cm) and the separation between the two compartments within the plasma system was removed so that all the pumping was carried out by means of the turbo-molecular pump and thus operating at a process pressure of around 10-50 mTorr (1.33-6.7 Pa).

A roll of hardcoated polymeric film from above was mounted within the chamber, the film wrapping around the drum electrode and secured to the take up roll on the opposite side of the drum. The unwind and take-up tensions were maintained at 8 pounds (13.3 N) and 14 pounds (23.3 N) respectively. The chamber door was closed and the chamber was pumped down to a base pressure of 5×10−4 torr (6.7 Pa). For the deposition step, hexamethyldisiloxane (HMDSO) and oxygen were introduced at a flow rate of 200 standard cm³/min and 1000 standard cm³/min respectively, and the operating pressure was nominally at 35 mTorr (4.67 Pa). Plasma was turned on at a power of 9500 watts by applying rf power to the drum and the drum rotation initiated so that the film was transported at a speed of 10 feet/min (3 m/min). The run was continued until the entire length of the film on the roll was completed.

After the completion of the DLG deposition step, the rf power was disabled, the flow of HMDSO vapor was stopped, and the oxygen flow rate increased to 2000 standard cm³/min. Upon stabilization of the flow rate, and pressure, plasma was reinitiated at 4000 watts, and the web transported in the opposite direction at a speed of 10 ft/min (3 m/min), with the pressure stabilizing nominally at 14 mTorr (1.87 Pa). This second plasma treatment step was to remove the methyl groups from the DLG film, and to replace them with oxygen containing functionalities, such as Si—OH groups, which facilitated the grafting of the silane compounds to the DLG film.

After the entire roll of film was treated in the above manner, the rf power was disabled, oxygen flow stopped, chamber vented to the atmosphere, and the roll taken out of the plasma system for further processing.

The thickness of resulting DLG layer was about 60 nm.

Tensile Testing Test Method Tensile specimens were cut from coated films using a cutter to obtain 25 cm long×12.7 mm wide specimens. Tensile testing was done using an Instron model 55R1122 universal load frame with flat grips according to ASTM D882-12. For all samples, the initial grip spacing was 5.1 cm, and the crosshead speed was 100 mm/min. The temperature during testing was 20±2° C. The nominal film thickness was utilized to determine modulus and tensile strength, which neglected the adhesive thickness. All results are the average of 5 tested specimens.

TABLE 3
Tensile Test Results

| | | | Nominal | | | | | Load |
|---|---|---|---|---|---|---|---|---|
| | | | thickness | | Ultimate | | Load | @ 25% |
| | | | without | Tensile | Tensile | Elongation | @ 25% | strain/mm |
| | Hard | DLG | adhesive | modulus | Strength | at break | strain | film width |
| Film | Coat | coating | (mil) | (MPa) | (MPa) | (%) | (N) | (N/cm) |
| Control | No | No | 5 | 6480 | 154 | 70 | 196 | 154.3 |
| PET | | | | | | | | |
| Control | No | No | 6 | 52 | 55 | 410 | 11 | 8.7 |
| PUA | | | | | | | | |
| 8518 | No | No | 2 | 1140 | 25 | 200 | 11 | 8.7 |
| Control | No | No | 6 | 80 | 24 | 240 | 8 | 6.3 |
| PUB | | | | | | | | |
| Ex. 22 | Yes | No | 5 | 5740 | 158 | 100 | 198 | 155.9 |
| PET | | | | | | | | |
| Ex. 23 | Yes | No | 6 | 63 | 35 | 310 | 10 | 7.9 |
| PUA | | | | | | | | |
| Ex. 24 | Yes | No | 2 | 940 | 23 | 100 | 10 | 7.9 |
| 8518 | | | | | | | | |
| Ex. 25 | Yes | No | 6 | 55 | 34 | 330 | 6 | 4.7 |
| PUB | | | | | | | | |
| Ex. 26 | Yes | Yes | 5 | 5730 | 131 | 50 | 201 | 158.3 |
| PET | | | | | | | | |
| Ex. 27 | Yes | Yes | 6 | 61 | 32 | 280 | 10 | 7.9 |
| PUA | | | | | | | | |
| Ex. 28 | Yes | Yes | 2 | 825 | 21 | 110 | 10 | 7.9 |
| 8518 | | | | | | | | |
| Ex. 29 | Yes | Yes | 6 | 91 | 20 | 240 | 6 | 4.7 |
| PUB | | | | | | | | |

### Example 30

The hardcoat coating composition of EX. 21 with 2% Esacure One photoinitator was applied Polyurethane film A (PUA), Scotchguard™ Paint Protection Film Pro Series obtained from 3M Company, St. Paul, Minn.

The hardcoat coating composition was cured at 10 ft/min using a 300 W. Fusion H bulb system. The cured hardcoat had a thickness of about 5 microns. The cured hardcoat was then coated with DLG as described above, and zwitterionic silane.

Hydrophilic Silane Solution was prepared by combining 49.7 g of a 239 nmol solution of 3-(N,N-dimethylaminopropyl)trimethoxysilane, 82.2 g of deionizod (DI) water, and 32.6 g of a 239 mmol obects solution of 1,4-butane sultone in a screw-top jar. The mixture vas heated to 75° C., mixed, and allowed to react for 14 hours. The structure of zwitterionic silane was:

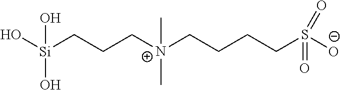 [SMILES: C[N+](C)(CCCCS(=O)(=O)[O-])CCC[Si](O)(O)O]

This 1% zwitterionic silane solution was coated using a continuous roll-to-roll process equipped with a direct forward gravure coater. A gravure roll with a tri-helical pattern and a volume factor of 12 BCM (billions of cubic microns) per square inch was employed to transfer the coating solution in a pan onto a moving web, forming a uniform wet layer of coating solution. The coating solution was subsequently dried and cured by passing through a gas-driven oven at 240-280 F. The average oven residence time of web is about 1 min. The resulting zwitterionic silane coating had a thickness of about 60-70 nm.

### Example 31

Example 30 was repeated except that the hardcoat was omitted.

### Example 32

Example 30 was repeated except that 8518 vinyl film obtained from 3M Company, St. Paul was utilized instead of Polyurethane film A (PUA).

### Example 33

Example 32 was repeated except that the hardcoat was omitted.

Examples 30-33 were tested using the following Durability Test:

### Durability Test

1. Cut 1 inch by 1-inch pieces of Scotchbrite 98 pads.
2. Attach the 1-inch square pieces of abrading material to the head of the linear Taber abrader using tape VHB tape.
3. Add 750 g of weights to the linear Taber abrader arm.
4. Secure the film to be abraded on a piece of glass with tape and place under the linear Taber abrader.
5. Apply 1 mL of water to the scour path and lower the linear Taber abrader head with the 1-inch square of abrasive media attached to the surface of the film and cycle at 60 cycles/min with a 2-inch scour path
6. Stop after desired cycles have been performed.
7. Test using Film Soiling and Cleaning described below.
8. Repeat procedure for additional cycles or as desired.

### Film Soiling

To apply marks for testing the following procedure was used.
1. Select following marker (Black or Red) and immobilize on the arm of a linear Taber abrader.

### Black Marker—The Sharpie® Pro King Size Permanent Marker—Newell Brands Inc. 6655

### Peachtree Dunwoody Road Atlanta, Ga. 30328 OR

Red Marker—Avery® Marks-A-Lot® Large Desk-Style Permanent Marker, Chisel Tip, Red (08887 from Avery Dennison Neenah, Wis.)
2. Allow the marker to rest on the substrate with 350 g of force (loading of arm).
3. Apply in a single direction one stroke of the marker while under load. Do not allow marker to retrace its path and overcoat the line.
4. Let mark dry for 5 minutes, longer drying will result in more difficult to remove marks.

### Cleaning

To evaluate removability of the marker(s) the follow procedure was used.
1. Apply 750 g of weights to the linear Taber abrader arm.
2. Immobilize the film with mark on a flat piece of glass so that the linear Taber abrader arm will contact the film near the mark, but not touching it.
3. Attach a trifolded paper towel (Wypall X30) to the head of the linear Taber abrader with a double wrapped rubber band, ensuring a secure fit that provides an evenly covered surface with no metal of the Taber head attachment contacting the surface.
4. Apply 1 mL of deionized water to 1″ length of the marker line evenly on both sides to be tested and allow to sit for 10 seconds.
5. Lower the head of the linear Abrader to contact the film surface near the mark.
6. Cycle the linear Taber abrader across the mark and back (across and back=1 cycle) the number of cycles indicated in the following table and record the % mark removed in the wiped area to the nearest 5%.

TABLE 4
Durability of Marker Removability

| Example 30 (PUA + | | % of Black | % of Red |
|---|---|---|---|
| HC + DLG + silane) | Cycles | Marker Removed | Marker Removed |
| | 0 | 100 | 100 |
| | 500 | 100 | 100 |
| | 1000 | 100 | 100 |
| | 2000 | 100 | 100 |
| | 3000 | 100 | 100 |
| | 4000 | 100 | 100 |
| | 5000 | 100 | 95 |
| | 7000 | 100 | 85 |
| | 10000 | 80 | 60 |
| | 0 | 100 | 100 |
| Example 31 (PUA + | 1000 | 75 | 65 |
| DLG + silane) | 2000 | 40 | 40 |

TABLE 5
Durability of Marker Removability

| Example 32 (PVC | | | |
|---|---|---|---|
| 8518 + HC + | | % of Black | % of Red |
| DLG + silane) | Cycles | Marker Removed | Marker Removed |
| | 1000 | 95 | 100 |
| | 2000 | 95 | 100 |
| | 3000 | 90 | 95 |
| | 4000 | 90 | 95 |
| | 5000 | 90 | 95 |
| | 6000 | 85 | 95 |
| | 7000 | 85 | 95 |
| | 8000 | 70 | 90 |
| | 9000 | 65 | 90 |
| | 10000 | 65 | 80 |
| Example 33 (PVC | 1000 | 80 | 90 |
| 8518 + DLG + silane) | 2000 | 40 | 50 |

1. An article comprising:
an organic polymeric base member;
a hardcoat layer disposed on the organic polymeric film, wherein the hardcoat layer can be stretched 25-75% without cracking;
a siliceous layer disposed on hardcoat layer, wherein the siliceous layer has a porosity of no greater than 10% and a thickness no greater than 1 micron; and
a surface layer comprising a zwitterionic compound bonded to the siliceous layer.

2. The article of claim 1 wherein the organic polymeric base member and article exhibits a load at 25% strain of no greater than 20 N/cm film width, as determined with tensile testing with a crosshead speed of 100 mm/min.

3. The article of claim 1 wherein the organic polymeric base member is a film having an elongation at break of at least 150%, as determined with tensile testing utilizing a stain rate of 200%/min.

4. The article of claim 1 wherein the hardcoat layer has a thickness of 2 to 10 microns.

5. The article of claim 1 wherein the hardcoat layer comprises at least one polymerized urethane (meth)acrylate oligomer having an elongation at break of at least 50, 75, or 100%, as determined with tensile testing utilizing a stain rate of 200%/min.

6. The article of claim 5 wherein the polymerized urethane (meth)acrylate oligomer is present in an amount of at least 50, 60, 70, 80, 90 or 100 wt.-% based on the wt.-% solids of the organic component.

7. The article of claim 1 wherein the hardcoat layer further comprises polymerized units of an ethylenically unsaturated monomer, wherein a homopolymer of the ethylenically unsaturated monomer has a glass transition temperature greater than 25, 30, 35, 40, 45, 50, 55, 60 or 65° C.

8. The article of claim 6 wherein the hardcoat layer comprises no greater than 35 or 30 wt.-% of polymerized units of acrylic polymer based on the wt.-% solids of the organic component.

9. The article of claim 7 wherein the polymerized units of an ethylenically unsaturated monomer and urethane (meth)acrylate oligomer and are present at a weight ratio ranging from 1:1 to 1:10.

10. The article of claim 7 wherein ethylenically unsaturated monomer comprises acid groups, hydroxyl groups, or a combination thereof.

11. The article of claim 10 wherein the polymerized units of an ethylenically unsaturated monomer has a hydroxyl number and an acid number, and the sum of hydroxyl number and acid number ranges from 10 to 150.

12. The article of claim 4 wherein the polymerized urethane (meth)acrylate oligomer is the reaction product of a polyisocyanate, a hydroxyl-functional acrylate compound, and a caprolactone diol.

13. The article of claim 1 wherein the siliceous layer comprises 10 to 50 atomic percent carbon.

14. The article of claim 1 wherein the siliceous layer is a diamond-like glass layer.

15. The article of claim 1 wherein the siliceous layer has a refractive index greater than 1.458.

16. The article of claim 1 wherein the surface layer is writable with a permanent marker and the marker can be removed.

17. The article of claim 1 wherein the article is a graphic film or a protection film.

18. An article comprising:
an organic polymeric base member;
a hardcoat layer disposed on the organic polymeric film, wherein the hardcoat layer can be stretched 25-75% without cracking;
a siliceous layer disposed on the hardcoat layer, wherein the siliceous layer has a porosity of no greater than 10% and a thickness no greater than 1 micron.

19. (canceled)

20. An article comprising:
a hardcoat layer, wherein the hardcoat can be stretched 25-75% without cracking;
a siliceous layer disposed on the hardcoat layer, wherein the siliceous layer has a porosity of no greater than 10% and a thickness no greater than 1 micron.

21. (canceled)

22. A method of replenishing a hydrophilic surface on a writable and cleanable article, the method comprising:
providing a writable and cleanable article according to claim 1 wherein the surface layer comprises an at least partially depleted hydrophilic surface;
applying a cleaning and protecting composition to at least a portion of the surface layer; wherein the cleaning and protecting composition comprises:
a hydrophilic silane;
a surfactant; and
water; and
drying the cleaning and protecting composition to provide a dried surface having a replenished hydrophilic surface.
